(19) United States
(12) Patent Application Publication
(10) Pub. No.: US 2013/0321573 A1
(43) Pub. Date: Dec. 5, 2013

(54) IDENTIFICATION AND DISPLAY OF TIME COINCIDENT VIEWS IN VIDEO IMAGING

(71) Applicants: Nathan A. Buettner, Lewisville, TX (US); Marshall C. Capps, US, TX (US)

(72) Inventors: Nathan A. Buettner, Lewisville, TX (US); Marshall C. Capps, US, TX (US)

(73) Assignee: TEXAS INSTRUMENTS INCORPORATED, Dallas, TX (US)

(21) Appl. No.: 13/486,758

(22) Filed: Jun. 1, 2012

Related U.S. Application Data
(60) Provisional application No. 61/653,263, filed on May 30, 2012.

(51) Int. Cl. H04N 13/00

(52) U.S. Cl. 348/43; 348/E13.073; 348/E13.062

(57) ABSTRACT

Method are disclosed for identifying fields of imaging data for display of respective sets of same time coincident different views in a video steam, such as for identifying sets of left-eye and right-eye perspective views taken at the same time in the stereoscopic imaging of an image subject matter. The video stream includes coded markers in the imaging data which are detected to identify the fields for displaying views of the same set, and for distinguishing the fields of one set from those of another. In one embodiment, the fields of one set are identified by coding each field for display of a same solid primary color last line, and the fields of a next successive set are identified by coding each field for display of a same secondary color last line, using a secondary color that is complementary to the primary color.

This application claims the benefit of Provisional Application No. 61/653,263, filed May 30, 2012, the entirety of which is incorporated herein by reference.

### BACKGROUND

This relates to methods and apparatus for the identification and display of time coincident views in a video stream.

Video streams provided as inputs to display systems for the display of video images are typically formatted as successive frame sequences of video imaging and synchronization information. The streams may take the form of composite analog waveform signals or may take the form of a streams of digital data bit encodings. Analog video signals, such as NTSC, PAL or SECAM standard format signals, typically have blanked out vertical front porch, vertical synch interval and vertical back porch portions and active beam interval vertical display portions (see, e.g., signals described in U.S. Pat. No. 7,184,002, incorporated herein by reference). The blanked out portions provide timing information for synchronizing line scanning and signal processing circuits. The active portions provide luminance (brightness) and chrominance (hue and saturation) information that defines the lightness and color of the visible content for the displayed imaged subject matter. The analog streams may be used directly to drive image forming elements of an analog display system, e.g., to sequentially scan interlaced horizontal lines of an image onto a CRT display; or they may be sampled and converted to a digital data formats for driving the image pixel forming elements of a digital display system. Digital video signals, such as DTV or DVD standard format signals, are typically digital bit representations of the same types of timing and image visible content-forming information. For example, the image forming active portions of the digital video streams may include strings of n-bit Red, Green, Blue digital data word representations of luminance and chrominance data for energizing row-column (line-column) drivers to illuminate individual pixels of an LCD matrix array, or for setting individual “ON”/“OFF” states of pixel light modulating elements of a spatial light modulator (SLM) such as for setting the states of individual micromirrors in a Texas Instruments DLP™ deformable micromirror device (DMD).

The active portions of successive frames of video streams may include one or more fields of imaging data for the display of views of an image subject matter, wherein successive fields include different views taken at the same time of the same image subject matter. For example, Lipton U.S. Pat. No. 4,562,463, incorporated herein by reference, describes a video streaming format (known as “above-and-below,” “over-and-under,” or “top-and-bottom” stereoscopic view formatting) wherein frames have two active portion fields, one above the other and separated by an additional blanking area, with each field representing a time coincident different left- or right-eye perspective view of the same image subject. Other standard techniques for providing successive fields of time coincident different perspective views for imaging include “side-by-side” 3D formatting wherein frames for same time left- and right-eye views are presented side by side in each input frame (with no additional vertical blanking added); and “frame-sequential” 3D formatting wherein fields for time coincident left- and right-eye views are presented alternatingly, one view field per frame. Other examples of different views of same image subject matter taken at the same time include foreground and background views, far distance and close-up views, different angle views taken from different camera positions, etc. (Such views are taken simultaneously or in sufficiently close time proximity within a short time interval generally considered to be substantially taken at about the same time.)

The time coincident different left- and right-eye perspective views may be displayed sequentially or simultaneously. For example, left- and right-eye views may be displayed in alternating sequence in synchronism for viewing with corresponding alternating shuttering of right- and left-eye lenses in a 3D active eyewear system; of left- and right-eye views may be displayed simultaneously using different polarizations or color wavelengths for simultaneous viewing with corresponding differently polarization or color wavelength right- and left-eye lens filters in a 3D passive eyewear system. To accomplish this, the image data of the left- and right-eye view fields in the active imaging-content portions of the successive video stream frames must be separated and processed by video data processing circuitry to provide corresponding output signals to control the driving of the display system image forming components.

Lipton et al. U.S. Pat. No. 5,572,250, incorporated herein by reference, provides a field flag detector for a 3D over-and-under frame formatting scheme in which a blue line code is added to the bottom of the field of each perspective view field pair to identify the left- or right-eye perspective nature of the image defined by that field. For example, a left code (to signify the left-eye field of a stereo pair) may be signified when the first 25% of the active line contains fully saturated Blue video and no Red or Green video, followed by the remaining 75% of the active line being completely black, i.e., fully unsaturated Red, Green and Blue; and a right code (to signify the right-eye field of the stereo pair) may be signified when the first 75% of the active line contains fully saturated Blue video and no Red or Green video, followed by the remaining 75% of the active line being completely black. Another code (first 50% of the active line fully saturated Blue, with the remaining 50% black) is added to indicate low speed rates and the above-and-below formatting. Blue was chosen as the component most likely to be present alone at high values, and because Blue (in comparison to Red and Green) is the most difficult color for people to detect (see also Lipton et al. U.S. Pat. No. 7,184,002, incorporated herein by reference).

Although the field flag detector described in U.S. Pat. No. 5,572,250 may be helpful in identifying the “handedness” of each field of the stereo field pair in each frame, no active portion signifier is provided for identification of time different views that belong to the same stereo pair. The same code is used to identify all fields having the same “handedness” with no differentiation being made from one stereo pair to the next. Although “handedness” identification may be useful for some purposes, once formatting is identified the “handedness” can be typically be determined intrinsically because the same eye perspectives of each pair will appear in the same order for a given specified formatting. And, while an active portion code is provided in U.S. Pat. No. 5,572,250 to identify the slow rate and over-and-under stereo formatting, the described coding scheme does not provide for identifying each of a group of possible formatting schemes.

Other background information is given in Smith et al. U.S. Pub. No. 2004/0252756, Walker et al. U.S. Pub. No. 2007/0085902, Adkins et al. U.S. Pub. No. 2009/0051759, Stephens U.S. Pat. No. 4,979,033, Stuettler U.S. Pat. No. 5,870,137, Yee et al. U.S. Pat. No. 6,122,000, Bracke U.S. Pat. No. 7,411,611 and Paquette U.S. Pat. No. 7,817,166, all of which are incorporated herein by reference.

### SUMMARY

Described embodiments provide methods for identifying fields of frames of video streams that provide imaging data for display of same time coincident different views of image subject matter.

Described embodiments provide methods for distinguishing fields of frames of video streams that provide imaging data for display of same first time coincident different views of image subject matter, from fields of frames that provide imaging data for display of same second time coincident different views of image subject matter.

Described embodiments provide methods for displaying images using display devices driven by imaging data provided by fields of frames of video streams identified as belonging to sets of fields having imaging data for display of same time coincident different views of image subject matter.

The described frame identifying and display methods find particular use for identifying and displaying images in stereoscopic display systems which repeat and display images of views based on imaging data from successive pairs of fields for same time coincident left- and right-eye perspective views to provide a higher frame/field display rate than the frame/field video stream receipt rate. Examples of such display systems are given in U.S. Pub. Nos. 2004/0252756 and 2007/0085902 and in U.S. Pat. Nos. 5,870,137 and 7,411,611, previously mentioned.

### BRIEF DESCRIPTION OF THE DRAWINGS

Example embodiments are described with reference to accompanying drawings, wherein:

FIG. 1 illustrates a system for creating a video stream;

FIG. 2 illustrates a method for identifying time coincident view of a video stream;

FIG. 3 illustrates a system for displaying images from an input video stream;

FIG. 4 illustrates a method for displaying time coincident views from an input video stream;

FIGS. 5 and 6 illustrate modifications of the system and method of FIGS. 3 and 4; and

FIGS. 7A-7C, 8A-8C and 9 illustrate an implementation of an example coding scheme for imaging fields of sets of view taken at successive coincident time intervals.

### DETAILED DESCRIPTION OF EXAMPLE EMBODIMENTS

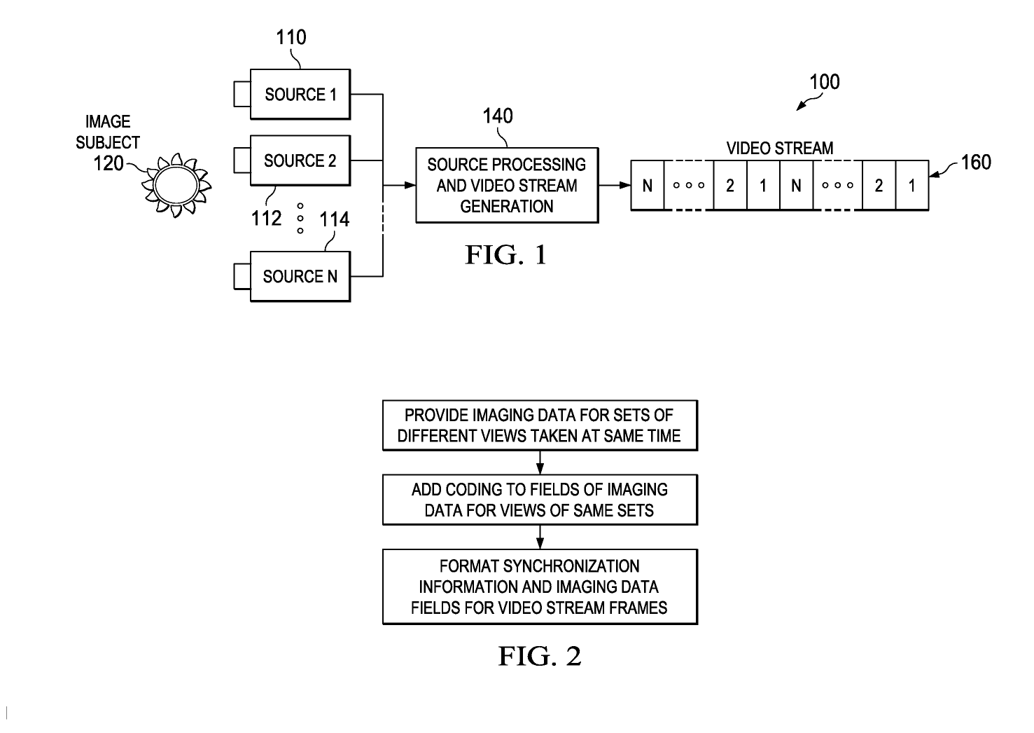

FIGS. 1 and 2 illustrate an example method for identifying fields of imaging data for display of respective sets of same time coincident different views in a video steam, such as for identifying sets of left-eye and right-eye perspective views taken at the same time in the stereoscopic imaging of an image subject matter.

A video stream generation system 100 has a plurality of image capture devices 110, 112, 114 which serve as image generation sources 1, 2, . . . , N for the capture of corresponding same time different views 1, 2, . . . , N of an image subject matter 120. The types and numbers of sources chosen will depend on needs and preferences for the particular application. In the case of stereoscopic imaging, system 100 may comprise two image capture sources 110, 112, such as digital video cameras with associated front end image capture circuitry, having fields of view (FOV) taken from locations spaced at eye pupil separation distance, to capture images of left- and right-eye perspective views. In the case of wide or 360° panoramic imaging, N≧3 sources 110, 112, 114 may be used with respective FOV intake optical axes appropriately angled to capture the desired overlap for seamless stitching. In the case of different same time view capture for sporting events, the number of sources N will depend on the number of camera angles or locations desired. The sources may utilize separate or shared image uptake channels.

Image data captured by sources 110, 112, 114 for the sets of different views taken at the same time is processed and formatted into a video data stream by source processing and video stream generation circuitry 140. First fields of imaging data are developed from the image data for the image views captured by source 110, second fields of imaging data are developed from the image data captured for the image views captured by source 112, etc. Circuitry 140 assembles the imaging data for the respective fields to provide a video data stream 160 comprising successive frames of video imaging and synchronization information, each frame including one or more of the respective different source fields, with the successive frames providing the imaging data of sets of fields for display of the same time coincident different views of the imaged subject matter. As part of assembling the fields of imaging data and formatting the video stream, circuitry 140 incorporates coding with the image data of the fields of each set as a marker to identify the fields that belong to the same set and to distinguish them from fields that belong to another set.

The video stream may take the form of a composite analog waveform or digital data bit signal. The synchronization information containing portions correspond to the blanked out portions that provide timing information for synchronizing line scanning and signal processing circuits, or similar display system control information. The imaging data field portions correspond to the active display portions that give the luminance and chrominance information for displaying the displayed visible content of the scanned lines, or equivalent, for the imaged subject matter. The coding incorporates a code within the imaging data to identify the imaging data fields of the same set. The code may take the form of modifying or replacing part or all of one or more lines of the imaging data (luminance and chrominance information) for the imaging data frames of each set. (For example, the code could take the form of a partial blue/partial black line added as a last display line to the displayed field, but—in contrast to the different left-right eye view identifiers described in U.S. Pat. No. 5,572,250—with the same code added to all imaging data frames of the same set, and a different code added to all imaging data frames of a next set.) The code may also take the form of coding for displaying part or all of a line of imaging data outside of the visible range (for example, in the infrared range, for display and detection in a system such as described in, e.g., Carver et al. US Pub. No. 2009/0060301 incorporated herein by reference).

One advantageous approach is to code the imaging data of each imaging data field for the respective different time coincident views belonging to the same set with luminance and chrominance data to display a single color last full horizontal line (or pixel row equivalent) marker. For example, in an 8-bit Red, Green, Blue digital coloring scheme (0-255 range for Red, Green and Blue) representation, each pixel position (or equivalent) on the last line of imaging data for the displayed image of the views of one set could be coded with a saturated primary color marker designation (maximum saturation luminance 255 for one of Red, Green or Blue; and minimum saturation luminance 0 for the other two of Red, Green and Blue). The last line of imaging data for each imaging data field for the time coincident views of the next set could then be coded with a secondary color marker which is complementary for the first set primary color marker (Cyan for Red, Magenta for Green, and Yellow for Blue), thereby giving a color designation (maximum 255 for two of Red, Green and Blue to give the complementary secondary color; and minimum 0 for the previously used primary color Red, Green or Blue) that when viewed immediately following the first set color would display in the visible spectrum as a perceived mid-level composite white line (medium luminance Red=128, Green=128 and Blue=128), if displayed.

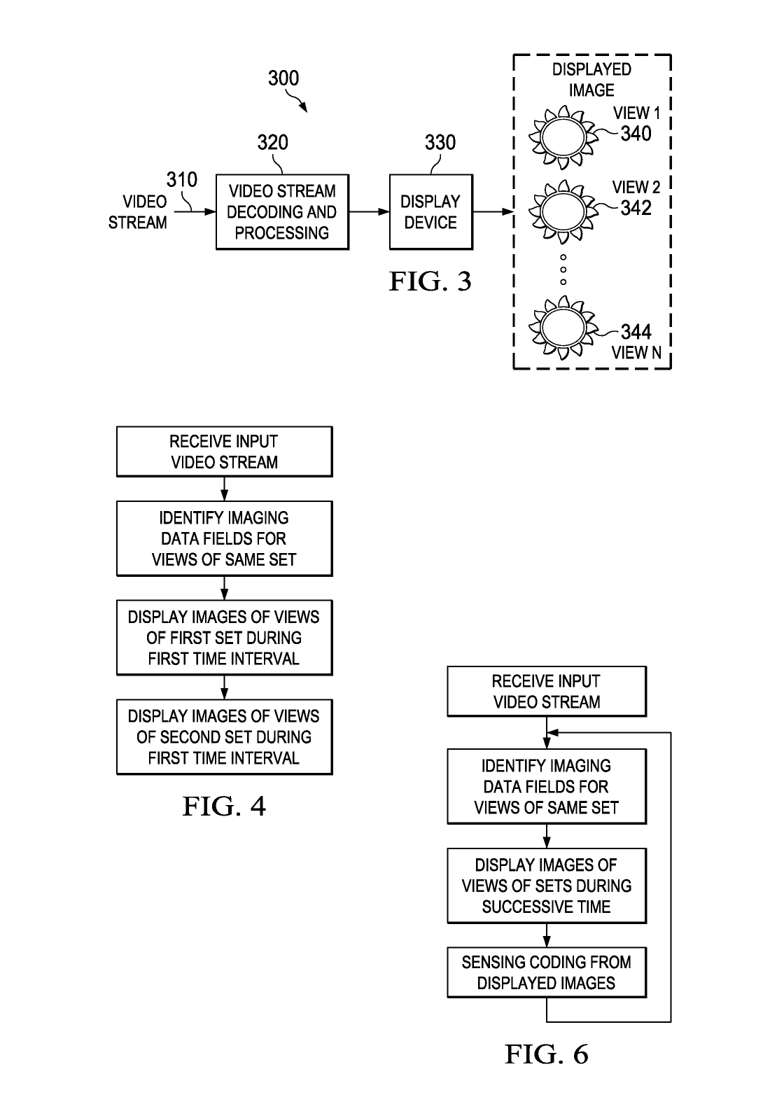

FIGS. 3 and 4 illustrate an example method for displaying images from a video data stream that includes coded markers for identifying fields of imaging data for display of respective sets of same time coincident different views, such for simultaneous or sequential display in close time proximity of left- and right-eye perspective views for stereoscopic viewing of an imaged subject matter.

A video display system 300 includes video data processing circuitry 320 for the decoding and processing of successive frames of video imaging and synchronization information received in an input video stream 310. The video stream may be received from any remote or local video signal source, and may take the form of the video stream 160 described above. Each frame includes one or more fields of imaging data for the display of a view of an image subject matter, with successive pluralities of fields providing imaging data for display of respective sets of same time coincident different views of the image subject matter. The imaging data of the fields of each set are coded with markings to identify the fields belonging to the same set and to distinguish fields of one set from the fields of another. The data processing circuitry detects the coding to identify which fields contain imaging data for the same set of time coincident different views of the image subject matter. The video data processing circuitry 320 extracts and processes the imaging data for the views to be displayed, and provides the data in a form for driving image forming elements of a display device 330 to display images 340, 342, 344 of the views of the identified fields. For example, in the case of stereoscopic imaging, system 300 identifies the sets of left- and right-eye perspective views and displays the different eye views 340, 342 of each set either simultaneously (e.g., for synchronized viewing with active shutter glasses) or sequentially (e.g., for simultaneous viewing with polarized or filtered passive glasses) in a same time interval. For example, in the case of wide or 360° panoramic imaging, system 300 identifies the N≧3 views of each set and displays them to provide respective appropriately angled FOV projections 340, 342, 344 onto a curved display surface with the desired overlap and stitching. For example, in the case of different same time views captured for sporting events, system 300 identifies the N different views of each set and may display one or more of them (340 and/or 342 and/or 344) in a same time interval in accordance with viewer view and/or presentation format selection (desired viewing angle or location; picture-in-picture; side-by-side; etc.).

The video data processing circuitry 320 may be configured to identify the marker encoded in the imaging data directly from the incoming data stream. This enables the views belonging to a same set to be tagged and handled together prior to projection. The coding can then be cropped or stripped from the imaging data so that it is not visible in the displayed image views 340, 342, 344 at all. Alternatively, the coding can be left for display and detection in the displayed images.

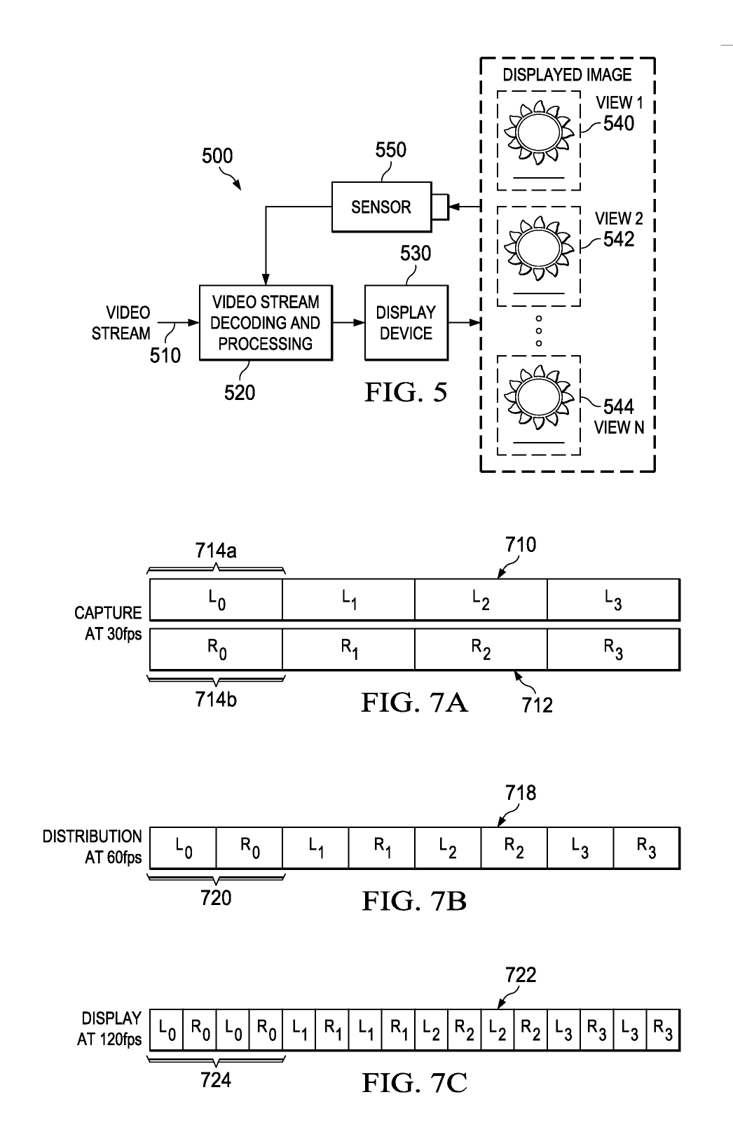

This is shown in FIGS. 5 and 6, wherein a display system 500 has a display device 530 driven by imaging data derived by video data processing circuitry 520 from an input video stream 510. The display device 530 displays images 540, 542, 544 of views of a particular set of views which include the displayed coding 550. In this case, a sensor 550 (which may be incorporated in an image capture functionality added in a return path in a projection system) senses the displayed coding 550 and feeds the detected signal back to the video data processing circuitry for feedback identification of the fields belonging to the same set. For example, if all views belong to the same set, the marking for all views displayed during the display time period allocated to each set should be the same. If the detected markings are not the same, the fields or frames can be shifted in the display buffers until the detected markings are the same. The displayed markings may, for example, take the form of the alternating primary/complementary secondary color last line codings discussed above. In such case, for short display intervals (relative to eye integration time) the markings will appear as mid-level composite lines as the last lines of the displayed images. Alternatively, the lines may be coded for display in a non-visible range. In such case, the last line marking will be detectable by sensor 550 (infrared detector) but not be visible to the viewer. (In appropriate arrangement, the infrared coding can be applied to a last line—or in any other chosen marking—at same pixel locations and without interference with other displayed image material.)

The imaging data fields coded with the set identification markings can be assembled into any framing format. For example, pairs of coded imaging data frames for left- and right-eye perspective views for stereoscopic imaging may be assembled into any of the top-and-bottom, side-by-side, or frame-sequential 3D formats. In the case of a solid last line visible coding, the last line of all imaging frames associated with the respective different views of image subject matter taken at the same first time interval may be coded for display of a first primary color line, and the last line of imaging frames associated with the different views taken at the next time interval will be coded for display of a first secondary color line which is color complementary to the first primary color line. The pattern can then be repeated for the next successive sets of images using the same primary and secondary colors, or using second and third primary colors and complementary secondary colors. For example, for 3D framing the first two fields for imaging a first pair of left- and right-eye views associated with a first time interval can both be coded for display of a solid Red last line, and the next two fields for imaging a second pair of left- and right-eye views associated with a second time interval can both be coded for display of a solid Cyan last line, with the last line coloring sequence (Red-Cyan) repeated for subsequent first and second field pairs. Alternatively, instead of repeating the Red-Cyan sequence, the next sets may be coded with other colors. For example, instead of repeating the red line for the third and fifth sets and the cyan line for the fourth and sixth sets, the third set may be coded with a Green line, the fourth with a Magenta line, the fifth with a Blue line and the sixth with a Yellow line. Similar coding may be applied to identify the frames of sets of frames for imaging time coincident views having more than two views per set (e.g., sets of six same time interval views for use in 360° panoramic displays), with the last line of each field of the set coded for display of a solid color.

The color sequence used for coding the different sets may be chosen based on individual needs and preferences. For instance, the color sequence pattern may be set to identify the framing format being used, so that the video data processing circuitry may detect not only the individual fields of the frames that belong to the same set, but may detect a specific pattern or cadence of the last line color codings from one set of fields to the next, with a different pattern or cadence signifying a particular framing format (e.g., above-and-below, side-by-side, or frame-sequential 3D format).

FIGS. 7A-7C, 8A-8C and 9 illustrate an implementation of an example coding scheme for imaging fields of sets of left- and right-eye view pairs taken at successive coincident time intervals. FIG. 7a shows respective streams 710, 712 of pairs 714a, 714b of left- and right-eye view images L₀, L₁, L₂, L₃, . . . , L_{N} and R₀, R₁, R₂, R₃, . . . , R_{N} captured at respective successive coincident time intervals T₀, T₁, T₂, T₃, . . . , T_{N} using a 30 field per second capture rate (i.e., captured at successive same 1/30 sec. time intervals). The captured images are combined into a composite analog or digital video stream 718 having successive frames of video imaging and synchronization information, each frame including one or more fields of imaging data for the display of one of the left- or right-eye view images, and with successive pairs of the fields providing imaging data for display of the respective left- and right-eye view images associated with the same one of the successive time intervals. The illustrated stream 718 may, for example, be formatted in top-and-bottom 3D format with the imaging data fields of both views L_{N}, R_{N} of the same set pair 720 positioned one above the other in one frame, in side-by-side 3D format with the fields for both views L_{N}, R_{N} of the same set pair positioned side by side in one frame, or in frame-sequential 3D format with the field for one view L_{N} of each set pair positioned in a first frame and the field for the other view R_{N} of the same set pair positioned in a next successive second frame. The video data processing circuitry of the display system may receive the video stream 718 at a distribution rate of 60 fields or frames per second (viz., in frame-sequential 3D format) and process the incoming L_{N}, R_{N} frame field pairs for simultaneous or sequential display of the respective reconstructed view pairs within sequential same time intervals corresponding to the time intervals utilized for the image capture. To avoid flicker, the frequency of the views may be multiplied (e.g., to a display rate of 120 fields or frames per second) with each view being displayed twice in close succession as illustrated by the display imaging data stream 722, with each displayed time coincident view set 724 including four views L_{N}, R_{N}, L_{N}, R_{N}.

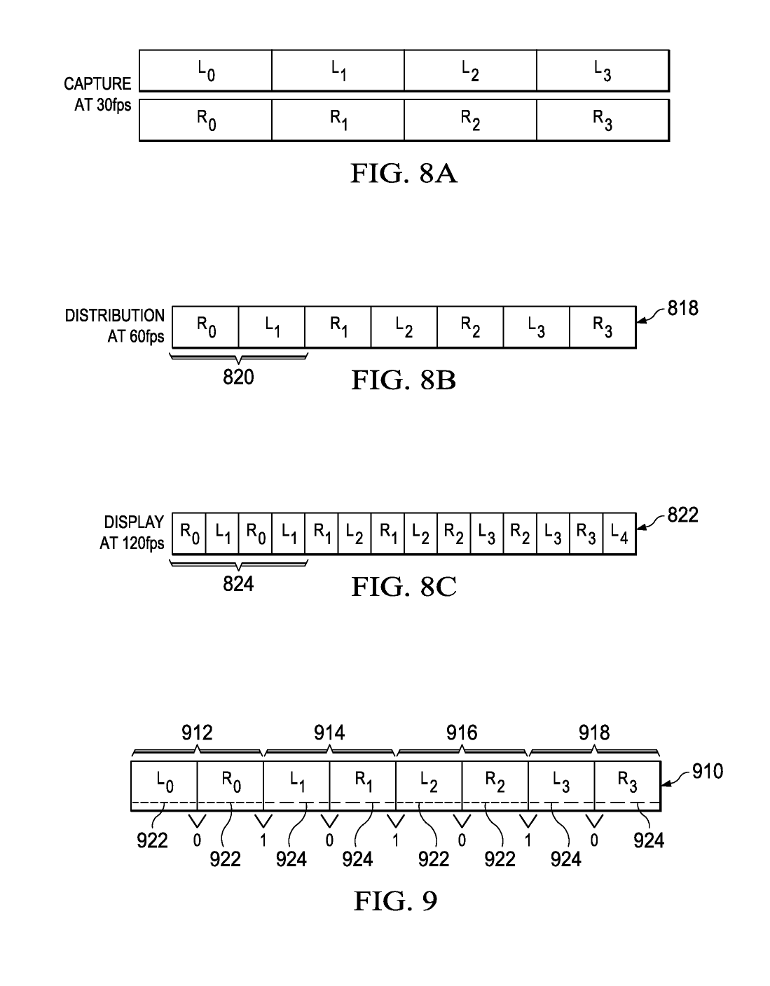

The framed fields 720 for each view pair 714a, 714b will typically have a known L, R or R, L sequence as shown in FIGS. 7A-7C. However, in the absence of an identification of the fields belonging to the same set, the fields for the same time coincident view set may become shifted as shown in FIGS. 8B and 8C, causing incorrect pairing of view field pairs 820 (R₀ with L₁ instead of L₀, R₁ with L₂ instead of L₁, etc.) from the input video stream 818 by the video data processing circuitry. The effect of the mismatch of pairs 824 becomes even more pronounced (R₀, L₁, R₀, L₁ instead of R₀, L₀, R₀, L₀, etc.) after multiplying the incorrect pairing in the establishment of the display data stream 822. Such pairing mismatch is prevented by coding the fields belonging to the same set of time coincident views in the incoming stream as illustrated in FIG. 9.

FIG. 9 shows a video data stream 910 with successive frames of video imaging and synchronization information, wherein each frame includes one or more fields of imaging data for the display of a view of an image subject matter, with successive pluralities of fields providing imaging data for display of respective sets of same time coincident different views of the image subject matter, and with the imaging data of the fields of each set including coding identifying the fields of that plurality as belonging to the same plurality and distinguishing those fields from the fields of a successive plurality. The illustrated example stream 910 has sets 912, 914, 916, 918 of fields of left- and right-eye perspective view image data pairs (set L₀, R₀ corresponding to views at time T₀; set L₁, R₁ corresponding to views at time T₁; set L₂, R₂ corresponding to views at time T₂; set L₃, R₃ corresponding to views at time T₃; etc.). The frames of each set include coding identifying the fields of the same set and distinguishing the fields of one set from those of a successive set. For the illustrated example, the imaging fields for both views L₀, R₀ of set 912 have a last line coded with a marker 922 for display of a solid line of a given one of a Red, Green or Blue primary color, and the imaging fields for both views L₁, R₁ of a neighboring set 914 have a last line coded with a marker 924 for display of a solid line of a given one of a complementary Cyan, Magenta or Yellow secondary color. The format of the stream 910 may be a frame-sequential format, wherein the left- and right-views of each set are allocated to different frames, one view per frame, with the successive frames ordering the fields of each set pair in a pre-specified given order (i.e., left-eye view first, right-eye view second, or vice versa). Although any variation of set codings can be applied, the shown ordering repeats the coding sequence of the fields of sets 912, 914 for the fields of the next sets 916, 918. Thus, in the illustrated example, the imaging fields for both views L₃, R₃ of set 916 have a last line coded with the same marker 922 as used for set 912 (i.e., same one Red, Green or Blue primary color), and the imaging fields for both views L₄, R₄ of set 918 have a last line coded with the same marker 924 as used for set 914 (i.e., same one Cyan, Magenta or Yellow secondary color). The video data processing circuitry detects the coding to identify the fields belonging to the same set, and to the same successive set. As indicated by the state signals 0, 1 in FIG. 9, the codings of each frame can be windowed and compared in the circuitry, with transitions from one coding to the next being characterized by one comparison output (e.g., logic state 0) if the coding is the same and by a different comparison output (e.g., logic state 0) if the coding is different. Fields giving a comparison coding indicating sameness (e.g., 0) are detected as belonging to the same set; fields giving a comparison coding indicating difference (e.g., 1) are detected as belonging to different sets. The pattern or cadence of the string of comparison outputs (e.g., 0101010) can be compared against stored known patterns to identify the formatting used and the number of views per set.

Those skilled in the art to which the invention relates will appreciate that modifications may be made to the described embodiments, and also that many other embodiments are possible, within the scope of the claimed invention.

What is claimed is:

1. A method for the display of images, comprising:
receiving at video data processing circuitry an input video stream comprising successive frames of video imaging and synchronization information, each frame including one or more fields of imaging data for the display of a view of an image subject matter, with successive pluralities of fields providing imaging data for display of respective sets of same time coincident different views of the image subject matter, and with the imaging data of the fields of each set including coding identifying the fields of that plurality as belonging to the same plurality and distinguishing those fields from the fields of a successive plurality;
with the video data processing circuitry, detecting the coding to identify the fields belonging to the same plurality and to the successive plurality;
using a display device driven by the imaging data provided for display of a first set of same time coincident different views by the fields identified as belonging to the same plurality, displaying one or more images of views of the first set during a first same time interval; and
using the display device driven by the imaging data provided for display of a second set of same time coincident different views provided by the fields identified as belonging to the successive plurality, displaying one or more images of views of the second set during a second same time interval.

2. The method of claim 1, wherein the sets of same time coincident different views are sets of same time coincident left-eye and right-eye perspective views.

3. The method of claim 2, wherein the successive pluralities of fields comprises a first field in a first frame providing imaging data for the display of one of the same time coincident left-eye and right-eye perspective views, and a second field in a second frame providing imaging data for the display of the other of the same time coincident left-eye and right-eye perspective views.

4. The method of claim 2, wherein the successive pluralities of fields comprises a first field in a frame providing imaging data for the display of one of the same time coincident left-eye and right-eye perspective views, and a second field in the same frame providing imaging data for the display of the other of the same time coincident left-eye and right-eye perspective views.

5. The method of claim 2, wherein detecting the coding includes identifying a cadence of a sequence of a number of fields belonging to a same plurality and to the successive plurality over a multiplicity of pluralities of fields, and determining a standard format for the input video stream based on such determining.

6. The method of claim 3, wherein the imaging data comprises luminance and chrominance data for displaying images of the views, and the coding comprises coding luminance and chrominance data for displaying an identifiable marker incorporated with the displayed image of the views.

7. The method of claim 6, wherein the marker is a visible light marker visible in the displayed image.

8. The method of claim 6, wherein the coding comprises coding luminance and chrominance data for displaying a primary color marker for identifying the fields belonging to the same plurality, and coding luminance and chrominance data for displaying a secondary color marker which is a complement of the primary color for identifying the fields belonging to the successive plurality.

9. The method of claim 6, wherein the first and second time intervals are completed within an eye image integration time, whereby the primary and secondary color markers combine to appear as a white composite marker.

10. The method of claim 9, wherein the primary color is one of red, green or blue; and the secondary color is a corresponding complementary one of cyan, magenta or yellow.

11. The method of claim 10, wherein the primary color marker coding provides an encoding for a maximum saturation luminance of the one of the red, green or blue and a minimum saturation luminance of other two of the red, green or blue; and the secondary color marker coding provides an encoding for a maximum saturation luminance of the other two of the red, green or blue and a minimum saturation luminance of the one of the red, green or blue; whereby the white composite marker appears as a medium luminance white.

12. The method of claim 7, wherein the coding comprises coding luminance and chrominance data for displaying the identifiable marker as a line of color incorporated with the displayed image.

13. The method of claim 8, wherein the line is one of last horizontal lines of the image.

14. The method of claim 12, wherein the line is a last full line of a single color.

15. The method of claim 6, wherein the marker is not visible in the displayed image.

16. The method of claim 15, wherein the marker is an infrared light marker.

17. The method of claim 16, wherein the marker is not displayed.

18. The method of claim 6, wherein the marker is a complete row line of a single color.

19. A method for identifying time coincident views in a video steam, comprising:
using a first image capture source, providing first fields of imaging data for display of first views of image subject matter;
using a second image capture source, providing second fields of imaging data for display of second views of the image subject matter, the second views corresponding to respective same time coincident different views of the image subject matter of the first views;
using video stream generation circuitry, providing a video data stream comprising successive frames of video imaging and synchronization information, each frame including at least one of the first and second fields, with the successive frames providing the imaging data of sets of the first and second fields for display of the respective same time coincident different first and second views of the image subject matter, and with the imaging data of the fields of each set including coding identifying the fields of that set as belonging to the same set and distinguishing those fields from fields of another set.

20. A method for identifying and displaying time coincident views in a video steam, comprising:
using first image generation circuitry, providing first fields of imaging data for display of first views of image subject matter;
using second image generation circuitry, providing second fields of imaging data for display of second views of the image subject matter, the second views corresponding to respective same time coincident different views of the image subject matter of the first views;
using video stream generation circuitry, providing a video data stream comprising successive frames of video imaging and synchronization information, each frame including at least one of the first and second fields, with the successive frames providing the imaging data of sets of the first and second fields for display of the respective same time coincident different first and second views of the image subject matter, and with the imaging data of the fields of each set including coding identifying the fields of that set as belonging to the same set and distinguishing those fields from fields of another set.
receiving at video data processing circuitry the video stream from the video stream generation circuitry;
comprising successive frames of video imaging and synchronization information, each frame including one or more fields of imaging data for the display of a view of an image subject matter, with successive pluralities of fields providing imaging data for display of respective sets of same time coincident different views of the image subject matter, and with the imaging data of the fields of each set including coding identifying the fields of that plurality as belonging to the same plurality and distinguishing those fields from the fields of a successive plurality;
with the video data processing circuitry, detecting the coding to identify the first and second fields belonging to a first set and to a second set;
using a display device driven by the imaging data provided for display of the first and second views of the fields identified as belonging to the first set, displaying one or both of the first and second views of the first set during a first same time interval; and
using the display device driven by the imaging data provided for display of the first and second views of a second set, displaying one or both of the first and second views of the second set during a second same time interval.
